(19) United States
(12) Patent Application Publication
(10) Pub. No.: US 2012/0189397 A1
(43) Pub. Date: Jul. 26, 2012

(54) DEVICE FOR SEALING

(75) Inventor: Lutfi BOZKURT, Winterlingen (DE)

(73) Assignee: GUEHRING OHG, Albstadt (DE)

(21) Appl. No.: 13/335,089

(22) Filed: Dec. 22, 2011

Related U.S. Application Data
(63) Continuation of application No. PCT/DE2010/000714, filed on Jun. 23, 2010.

(30) Foreign Application Priority Data
Jun. 24, 2009 (DE) 10 2009 030 327.8
Feb. 22, 2010 (DE) 10 2010 008 873.0

(51) Int. Cl. B23Q 11/10; B23C 5/28; F16J 15/02; B23C 5/26

(52) U.S. Cl. 409/135; 409/234; 277/650; 277/644; 277/637

(57) ABSTRACT

The application describes a device for sealing a coolant and/or lubricant channel, wherein the coolant and/or lubricant channel extends through a first tool part, a second tool part, and the device, wherein the device comprises a first section, a second section, and a center section. The first section can be connected to the first tool part. The second section is arranged in such a way that the second section can protrude into the coolant and/or lubricant channel of the second tool part, wherein the outer diameter of the second section is greater than or equal to the inner diameter of the coolant and/or lubricant channel of the second tool part. The center section is arranged between the first section and the second section.

### CROSS-REFERENCE TO RELATED APPLICATIONS

This application is a continuation of International Application No. PCT/DE2010/000714 having an international filing date of Jun. 23, 2010, and claims the benefit under 35 U.S.C. 119 sections (a)-(d) of German application 10 2009 030 327.8, filed Jun. 24, 2009, and German application 10 2010 008 873.0, filed Feb. 22, 2010, the entireties of which are incorporated herein by reference.

### DESCRIPTION

1. Field of the Invention

The present invention relates to a device for sealing a coolant and/or lubricant channel. The invention also relates to a flange and a tool system.

2. Background to the Invention

Tool systems can comprise a plurality of tool parts, through which coolant and/or lubricant channels have to be passed in order to supply the working parts of the tool system with coolant and/or lubricant.

### SUMMARY OF THE INVENTION

The interfaces of the individual tool parts present problems with regard to the sealing of the coolant and/or lubricant channel.

It can therefore be regarded as a problem of the present invention to make available a device for sealing a coolant and/or lubricant channel, especially at interfaces of two tool parts.

This problem is solved in the independent claims. Further advantageous embodiments of the invention emerge from the dependent claims.

As a first embodiment of the invention, a device for sealing a coolant and/or lubricant channel is made available, wherein the coolant and/or lubricant channel runs through a first tool part, through a second tool part and through the device, wherein the device comprises: a first section, wherein the first section can be connected to the first tool part, a second section, wherein the second section is arranged in such a way that it can protrude into the coolant and/or lubricant channel of the second tool part, wherein the outer diameter of the second section is greater than or equal to the inner diameter of the coolant and/or lubricant channel of the second tool part, and a central section, wherein the central section is arranged between the first section and the second section.

The first and/or second tool part can comprise a hollow shank cone or a tapered cone or a holding fixture for a tool or a chuck. The coolant and/or lubricant channel can be arranged leading centrally and/or non-centrally through the tool parts.

The second section of the device, in particular, is used for the sealing. For this purpose, the outer diameter of the second section has an excess compared to the inner diameter of the coolant and/or lubricant channel. This thus ensures that a gap cannot arise between the device and the inner wall of the coolant and/or lubricant channel, which could lead to leakages.

The device for sealing is especially advantageous, since no further devices or methods are required to ensure the tightness of the interface. In particular, it is possible to dispense with the grinding of contact faces of the interface to achieve a low degree of roughness or waviness.

As a second embodiment of the invention, a flange comprising a first plate and a second plate is made available, wherein the first plate can be connected to the second plate, wherein the second plate comprises holes with an inner thread, into which screws can be screwed, as a result of which the tips of the screws sit on the first plate, the second plate comprising at least six holes with an inner thread.

A detachable connection between two tool parts is achieved for example by means of a flange, wherein the two plates of the flange can be screwed or clamped together. If a tool part comprises for example a chuck for a tool, it has to be ensured that this tool part runs concentrically during rotation. For this purpose, it may be necessary to tilt the chuck in relation to the connected tool part. This can be achieved by means of screws which are screwed into the flange plate of the chuck, as a result of which the latter are pressed against the second flange plate, as a result of which an inclination of the chuck with respect to the other tool part can result. To advantage, at least six screws are used for this purpose, distributed uniformly or non-uniformly over the periphery of the flange plate, in order to enable a very precise adjustment. This thus ensures exact concentricity of the chuck.

As a third embodiment of the invention, a tool system is made available that comprises a first tool part with a first plate of a flange, and a second tool part with a second plate of the flange, wherein the first tool part can be connected to the second tool part by means of the flange, wherein the second plate comprises holes with an inner thread, into which screws can be screwed, as a result of which the tips of the screws sit on the first plate, wherein the second plate comprises at least six holes with an inner thread.

According to an exemplary embodiment of the invention, a device is made available, wherein the device is elastic. Through the elastic constitution of the device, an expansion of the device after introduction into the coolant and/or lubricant channel is enabled, as a result of which the tightness of the coolant and/or lubricant channel is achieved. Furthermore, the elasticity of the device facilitates the assembly of the tool parts, since precise guidance of the tool parts during assembly can be dispensed with.

In a further embodiment according to the invention, a device is made available, wherein the device is tubular. The device can thus be placed adjacent to the coolant and/or lubricant channel along an entire section, as a, result of which leaks between the device and the coolant and/or lubricant channel can be reliably prevented.

According to a further example of embodiment of the present invention, a device is made available, wherein a part of the central section is arranged in such a way that it can protrude into the coolant and/or lubricant channel of the second tool part.

Through an advantageous embodiment with a device for sealing that protrude well into the coolant and/or lubricant channel, a tight coolant and/or lubricant channel is also guaranteed, for example, during assembly work on the tool parts, especially when the tool parts do not have to be taken apart, but their connection nonetheless has to be loosened.

According to an exemplary embodiment of the invention, a device is made available, wherein the device comprises: a disc which can be connected to the first tool part, wherein the disc comprises a through-going recess into which the first section can be inserted.

The device advantageously comprises a plurality of parts, e.g. two parts, as a result of which production of complicated components can be avoided. Instead, simpler parts can thus be produced or recourse can be taken to standard parts in the production of the device for sealing. The disc can furthermore be inserted into the tool part early on during production without there being the need for concern that damage due to projecting parts could arise during the subsequent course of production.

In a further embodiment according to the invention, a device is made available, wherein the disc is elastic. The device for sealing can be introduced more easily into an elastic disc, as a result of which the assembly is simplified.

According to a further example of embodiment of the present invention, a device is made available, wherein the first section has an outer diameter which is greater than the outer diameter of the central section.

According to an exemplary embodiment of the invention, a device is made available, wherein the second section has an outer diameter which is greater than the outer diameter of the central section.

An easier assembly of the device with the tool parts results from a structure with one or two thickened ends of the device for sealing and a central section that is slender in comparison therewith, since greater degrees of freedom arise during swiveling of the device in relation to the tool parts.

In a further embodiment according to the invention, a device is made available, wherein the device has a constant outer diameter. This leads to a very simple structure of the device, as a result of which production costs can be minimised.

According to a further example of embodiment of the present invention, a device is made available, wherein the device comprises a seal in the second section. As a result of an additional seal (besides the second section itself), the reliability of the tightness achieved with the device is increased.

According to an exemplary embodiment of the invention, a device is made available, wherein the seal is an O-ring.

According to an exemplary embodiment of the invention, a device is made available, wherein the device comprises: an outer thread for the detachable connection to the first and/or second tool part and/or an O-ring for the sealing to the first and/or second tool part.

The device for sealing according to the invention can be provided with one or more outer threads in order to create a detachable connection with one or more tool parts, as a result of which it is ensured that the device for sealing cannot slip, for example during assembly of the tool parts, and thus lose its sealing function. In a further embodiment, the device for sealing can also be provided with O-rings, as a result of which a still better sealing function can be achieved.

In a further embodiment according to the invention, a tool system comprising a first tool part and a second tool part is made available, wherein the first tool part can be connected to the second tool part, wherein a coolant and/or lubricant channel runs through the first tool part and through the second tool part, wherein the tool system comprises a device according to any one of claims 1 to 12.

It can be regarded as an aspect of the invention to make available a seal (device for sealing) which connects the coolant and/or lubricant channels of two tool parts to one another, wherein the tightness of the coolant and/or lubricant channel is secured by the tubular design of the seal even when there is a limited movement-apart of the tool parts concerned. Furthermore, a further aspect of the invention is the arrangement of at least six screws on a contact plate of a flange, as a result of which the tip of the screws is pressed against the complementary flange plate in order to enable tilting of the one tool part with respect to the other tool part. A very good concentricity can be established through the use of at least six screws, which can drastically increase the quality of holes, for example.

The individual features can of course also be combined with one another; as a result of which advantageous effects can in part also appear that go beyond the sum total of the individual effects.

### BRIEF DESCRIPTION OF THE DRAWINGS

Further details and advantages of the invention will become clear on the basis of the examples of embodiment represented in the drawings. In the figures:

FIG. 1 shows a longitudinal section of two tool parts,

FIG. 2 shows a longitudinal section of a tool part,

FIG. 3 shows a plate of a flange,

FIG. 4 shows a longitudinal section of a tool part,

FIG. 5 shows a plate of a flange,

FIG. 6 shows a device for sealing,

FIG. 7 shows a device for sealing,

FIG. 8 shows a longitudinal section of two tool parts,

FIG. 9 shows a longitudinal section of two tool parts with a further device for sealing according to the invention.

### DETAILED DESCRIPTION OF THE EXEMPLARY EMBODIMENTS

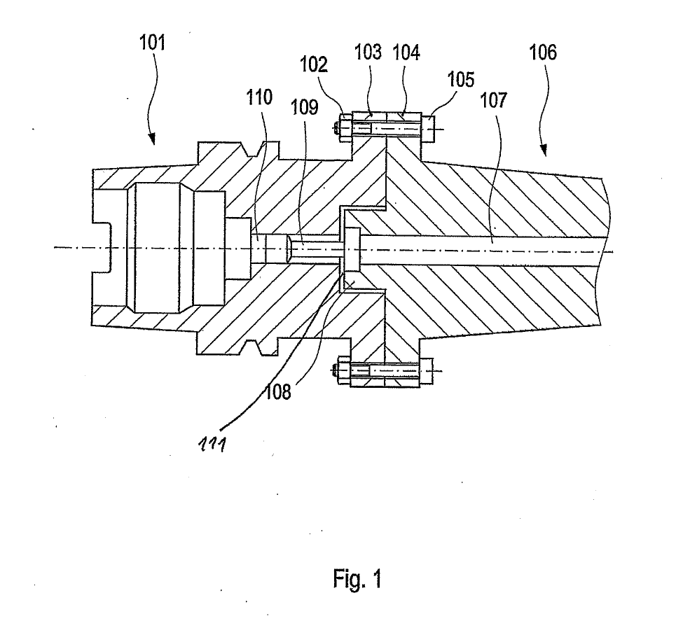

FIG. 1 shows two tool parts 101, 106, which are jointed together by means of a flange. Tool part 101 comprises a hollow shaft cone and a plate 103 of a flange. Tool part 106 comprises a holding fixture for a tool and a complementary plate 104 of a flange, which can be screwed to first plate 103 of the flange. For this purpose, plates 103, 104 of the flange comprise aligned holes, through which screws 105 can be passed and can be screwed up with nuts 102. The jointing-together of plates 103, 104 of the flange can also be carried out by means of threaded bolts, the latter being screwed up with nuts 102 on both sides of the flange. A plate 103 of the flange can also comprise holes with a thread, into which screws 105 can engage, as a result of which the two tool parts 101, 106 can also be jointed together in a detachable manner. Screws 105 can also be arranged countersunk in plate 104 of the flange. Tool parts 101, 106 comprise coolant and/or lubricant channels 107, 110, which enable delivery of the coolant and/or lubricant from the hollow shaft cone up to the working parts of the tool (not represented). In order that the coolant and/or lubricant does not escape at the interface of the two tool parts, the flange, a device for sealing 109 is provided. This device for sealing 109 is anchored in a protrusion 108 of tool part 106 and protrudes into coolant and/or lubricant channel 110 of tool part 101. Device for sealing 109 comprises a section with a greater diameter, this diameter having an excess in comparison with the inner diameter of coolant and/or lubricant channel 110. This section of device for sealing 109 thus lies tightly against the inner walls of coolant and lubricant channel 110, as a result of which coolant and/or lubricant channel 110 is sealed. Device for sealing 109 serves in particular to prevent coolant and/or lubricant from getting into gap 111 between tool parts 101, 106.

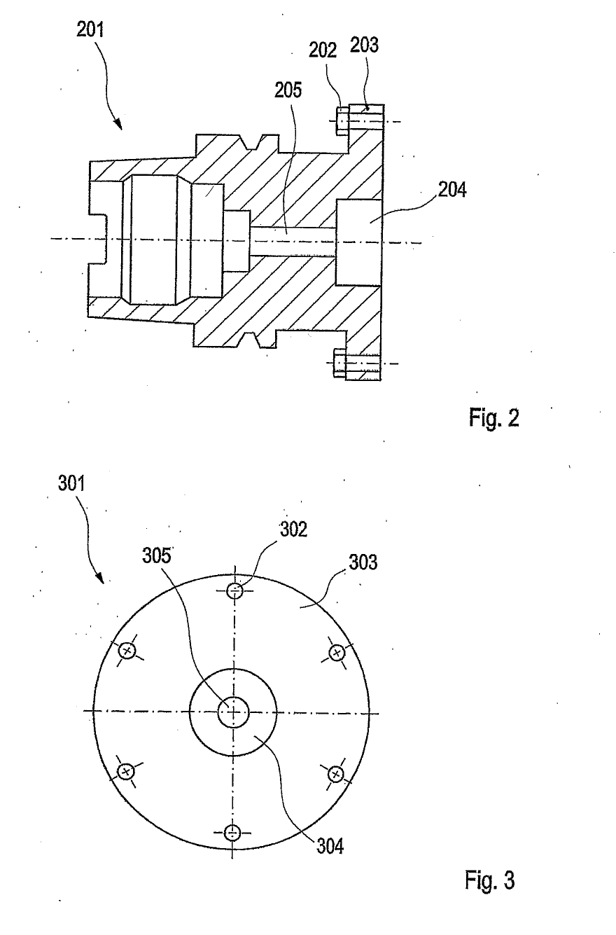

FIG. 2 shows tool part 201 with the hollow shaft cone, wherein tool part 201 also comprises a plate 203 of a flange. Furthermore, the tool part comprises a recess 204, into which a complementary protrusion of a second tool part can be inserted. As a result of the combination of recess/protrusion, sealing of the interface of the flange can be achieved, especially when the contact faces of flange 203 are characterised by slight roughness or waviness. Coolant and/or lubricant can thus be conveyed in a channel 205 through tool part 201.

FIG. 3 shows a front view of a plate 303 of a flange of a tool part 301. Plate 303 of the flange that belongs to tool part 201 of FIG. 2 is depicted here. Plate 303 comprises holes 302 for the jointing-together, wherein holes 302 can comprise inner threads. Furthermore, recess 304 is represented as well as coolant and/or lubricant channel 305.

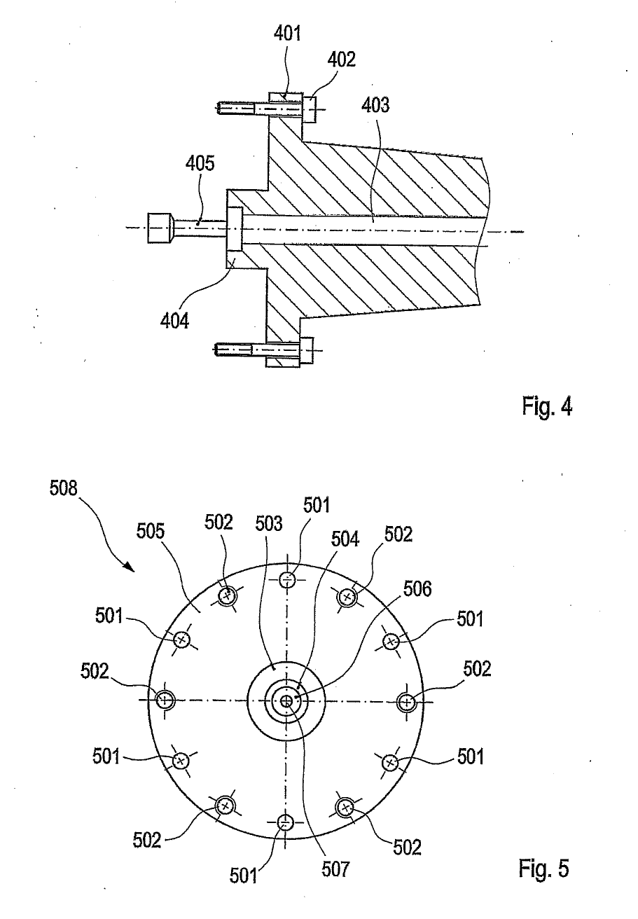

FIG. 4 shows a tool part, wherein the tool comprises a protrusion 404 and a device for sealing 405, which is constituted as a tube. The represented tool part can be jointed together with a second tool part by means of plate 401 of the flange, wherein protrusion 404 protrudes into the second tool part and device for sealing 405 serves to seal the interface.

FIG. 5 shows a front view of a tool part 508, wherein plate 505 of a flange that belongs to the tool according to FIG. 4 is represented. Represented here are six holes 501 for the jointing-together of this tool part 508 with a further tool part, as well as a further six holes 502 for tilting tool part 508 in relation to the further connected tool part. Holes 501 have complementary holes in the further work part, so that jointing-together can be achieved. Holes 502 do not have any corresponding holes in the plate of the further tool part. Furthermore, holes 502 comprise inner threads. Screws can thus be screwed into holes 502, the screw tips whereof sit on the plate of the further tool part, as a result of which tilting of the two tool parts with respect to one another can be achieved. Furthermore, protrusion 503 is represented, the section of device for sealing 504 that is anchored in protrusion 503, as well as the front section of device for sealing 506 that protrudes' into the further tool part, as well as coolant and/or lubricant channel 507.

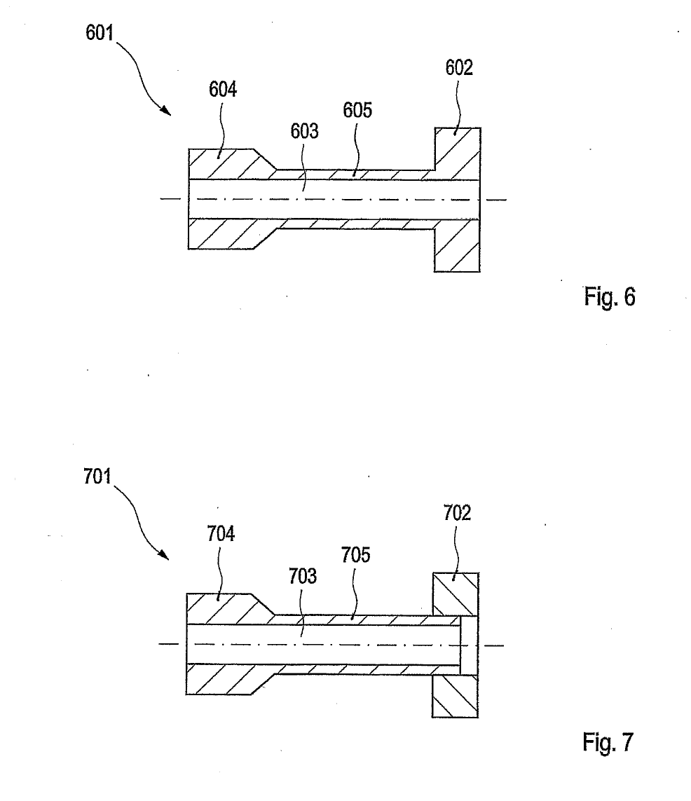

FIG. 6 shows a device for sealing 601 with a front section with a greater outer diameter 604, which can lock itself in position against the inner walls of the coolant and/or lubricant channel of a first tool part, as well as a section 602 also with a greater outer diameter 602, which can be connected to a second tool part.

FIG. 7 shows a further variant of a device for sealing 701, wherein device 701 extends in a disc 702 here. Disc 702 can be constituted so as to be insertable into a first tool part. Coolant and/or lubricant channel 703 can be constituted widened at one or also at both ends of device 701.

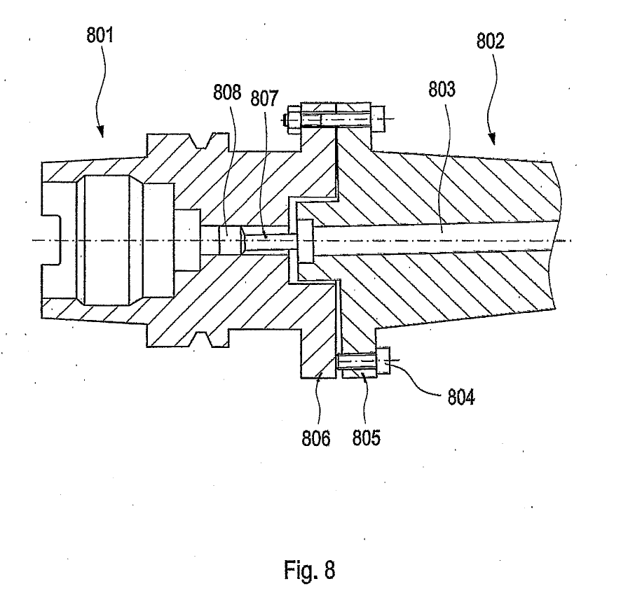

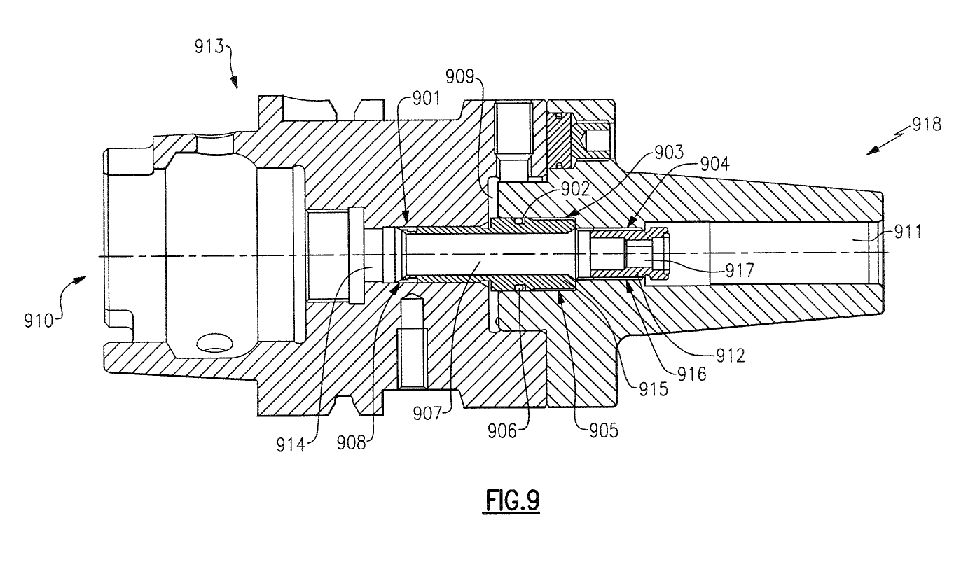

FIG. 8 shows two tool parts 801, 802, which are connected by a flange. Furthermore, tool part 802 is tilted with respect to tool part 801 in order to guarantee concentricity of the tool clamped in tool part 802. A gap between the plates of the flange 805, 806 can arise here. In order that coolant and/or lubricant channel 803 that passes through remains tight, a device for sealing 807 is provided, which extends from one tool part 802 into other tool part 801 and comprises a section with a greater diameter 808, which is constituted elastic and also guarantees sealing during tilting.

The tilting is achieved by means of screws 804, which can engage in an inner thread of plate 805 of the flange and the tips whereof sit on other plate 806 of the flange. At least six screws are preferably used in order to achieve good concentricity of tool part 802.

FIG. 9 shows a further inventive embodiment of a device for sealing 915, wherein device for sealing 915 serves to ensure a leakage-free connection of channels 914, 911 for coolant and/or lubricant of two tool parts 918, 913. In particular, device for sealing 915 prevents coolant and/or lubricant that is to be fed from central channel 914 to a tool insertable in hole 911 from getting into gap 909. According to the invention, therefore, a targeted use of the coolant and/or lubricant for cooling and/or lubricating the cutting sections of a tool inserted into hole 911, e.g. a drill, a milling tool, a turning tool of a reamer, is enabled as a result. Device for sealing 915 comprises a left-hand region with sealing regions 901, 908, which can be constituted for example as a sealing lip, also a central channel 907 for conveying coolant and/or lubricant as well as a seal, e.g. an O-ring 902, 906, for the sealing of device for sealing 915 with respect to at least one tool part 918, 913. A further O-ring can also be provided on further sections of the device for sealing, in particular to prevent an escape of coolant and/or lubricant into gap 909 between tool parts 913, 918. Device for sealing 915 can also comprise an outer thread 903, 905, which can be provided for the detachable connection of device for sealing 915 to one of the two tool parts 918, 913. In an alternative embodiment, the device for sealing can comprise a plurality of outer threads, in order to be able to create a detachable connection with one or with both tool parts 918, 913. In a further alternative embodiment, the device for sealing can comprise a plurality of O-rings. In a still further alternative embodiment, an O-ring can be arranged such that coolant and/or lubricant cannot pass to an outer thread or the outer threads of the device for sealing. Furthermore, an MMS screw 912 is represented, which can be used to adjust the clamping depth of the tool in hole 911, wherein MMS screw 912 can comprise for example an internal hexagon 917, into which a matching key can be inserted via channels 914, 907. By rotating the inserted key, MMS screw 912 can be put into a rotary movement. As a result of the rotary movement of MMS screw 912 and on account of outer thread 904, 916 of MMS screw 912, MMS screw 912 can be displaced to the left or to the right. If MMS screw 912 is displaced to the left, a tool can be inserted deeper in hole 911. If MMS screw 912 is displaced to the right, the tool can be inserted less deeply into hole 911.

It should be noted that the term “comprise” does not exclude further elements or process steps, just as the terms “a” and “one” do not exclude a plurality of elements and steps.

The employed reference numbers serve merely to increase understanding and should under no circumstances be regarded as limiting, the scope of protection of the invention being reproduced by the claims.

### LIST OF REFERENCE NUMBERS

101 tool part
102 nut
103 plate of a flange
104 plate of a flange
105 screw
106 tool part
107 coolant and/or lubricant channel
108 protrusion
109 device for sealing
110 coolant and/or lubricant channel
111 gap
201 tool part
202 groove
203 plate of a flange
204 recess
205 coolant and/or lubricant channel
301 tool part
302 hole
303 plate of a flange
304 recess
305 coolant and/or lubricant channel
401 plate of a flange
402 screw
403 coolant and/or lubricant channel
404 protrusion
405 device for sealing
501 hole
502 hole
503 protrusion
504 device for sealing
505 plate of a flange
506 device for sealing
507 coolant and/or lubricant channel
508 tool part
601 device for sealing
602 first section of a device for sealing
603 coolant and/or lubricant channel
604 second section of a device for sealing
605 central section of a device for sealing
701 device for sealing
702 first section of a device for sealing
703 coolant and/or lubricant channel
704 second section of a device for sealing
705 central section of a device for sealing
801 tool part
802 tool part
803 coolant and/or lubricant channel
804 screw
805 plate of a flange
806 plate of a flange
807 device for sealing
808 section with a greater outer diameter of a device for sealing
901 sealing lip
902 O-ring
903 outer thread
904 outer thread
905 outer thread
906 O-ring
907 channel
908 sealing lip
909 gap
910 HSK interface
911 hole
912 MMS screw
913 tool part
914 channel
915 device for sealing
916 outer thread
917 internal hexagon
918 tool part

1. A device for sealing a coolant and/or lubricant channel, the coolant and/or lubricant channel running through a first tool part, through a second tool part and through the device, the device comprising:
a first section connectable to the first tool part,
a second section arranged in such a way that the second section can protrude into the coolant and/or lubricant channel of the second tool part, the outer diameter of the second section being greater than or equal to the inner diameter of the coolant and/or lubricant channel of the second tool part; and
a central section arranged between the first section and the second section.

2. The device according to claim 1, wherein the device is elastic.

3. The device according to claim 1, wherein the device is tubular.

4. The device according to claim 1, wherein a part of the central section is configured to protrude into the coolant and/or lubricant channel of the second tool part.

5. The device according to claim 1, wherein the device comprises a disc connectable to the first tool part, the disc comprising a through-going recess into which the first section can be inserted.

6. The device according to claim 5, wherein the disc is elastic.

7. The device according to claim 1, wherein the first section has an outer diameter greater than the outer diameter of the central section.

8. The device according to claim 1, wherein the second section has an outer diameter greater than the outer diameter of the central section.

9. The device according to claim 1, wherein the device has a constant outer diameter.

10. The device according to claim 1, wherein the device comprises a seal in the second section.

11. The device according to claim 10, wherein the seal is an O-ring.

12. The device according to claim 1, wherein the device comprises an outer thread for the detachable connection to the first and/or the second tool part and/or an O-ring for sealing to the first and/or second tool part.

13. A tool system comprising:
a first tool part; and
a second tool part, the first tool part connectable to the second tool part, a coolant and/or lubricant channel running through the first tool part and through the second tool part, the tool system comprising a device according to claim 1.

14. A flange comprising:
a first plate; and
a second plate, the first plate connectable to the second plate, the second plate comprising holes with an inner thread, into which screws can be screwed, as a result of which tips of the screws sit on the first plate, the second plate comprising at least six holes with an inner thread.

15. A tool system comprising:
a first tool part with a first plate of a flange; and
a second tool part with a second plate of the flange, the first tool part connectable to the second tool part by the flange, the second plate comprising holes with an inner thread, into which screws can be screwed, as a result of which tips of the screws sit on the first plate, the second plate comprising at least six holes with an inner thread.
